(19) United States
(12) Patent Application Publication
(10) Pub. No.: US 2024/0297556 A1
(43) Pub. Date: Sep. 5, 2024

(54) INTEGRATED POLYPHASE ELECTRIC MACHINE

(71) Applicants: UNIVERSITÉ DE LILLE; CENTRALE LILLE INSTITUT; UNIVERSITÉ POLYTECHNIQUE HAUTS-DE-FRANCE; CENTRE NATIONAL DE LA RECHERCHE SCIENTIFIQUE; ECOLE NATIONALE SUPERIEURE ARTS ET METIERS (ENSAM); JUNIA

(72) Inventors: Eric SEMAIL, Lille (FR); Souad HARMAND, Lecelles (FR); Nadir IDIR, Tressin (FR); Betty SEMAIL, Lille (FR)

(21) Appl. No.: 18/268,738

(22) PCT Filed: Dec. 22, 2021
(86) PCT No.: PCT/FR2021/052435

§ 371 Date: Jun. 21, 2023

(30) Foreign Application Priority Data
Dec. 23, 2020 (FR) 20/14060

(51) Int. Cl. H02K 9/22; H02K 1/02; H02K 1/276; H02K 9/20; H02K 11/33

(52) U.S. Cl. CPC H02K 9/225; H02K 1/02; H02K 1/2773; H02K 9/20; H02K 11/33

(57) ABSTRACT

Polyphase electric machine including a first motion actuation assembly and a rotatable second motion actuation assembly, the first and second motion actuation assemblies together defining first and second opposing lateral faces, of the polyphase electric machine; the polyphase electric machine further having at least one phase generator including a plurality of control assemblies, each control assembly containing an input module and an output module, the input and output modules being arranged on the first lateral face and on the second lateral face of the polyphase electric machine.

### TECHNICAL FIELD

The present disclosure concerns a polyphase electric machine.

The present disclosure also concerns a vehicle including such a polyphase machine.

### BACKGROUND

The current polyphase electric machines use a stator interacting in rotation with a rotor. The supply of these polyphase electric machines is done for example with a driving module which controls the creation of out-of-phase magnetic fields in the stator. These interact with magnetic elements located on the part to be moving, that is to say the rotor, which causes a relative movement between the rotor and the stator by magnetic repulsion.

This principle of machine is known but however the existing machines do not make it possible to effectively limit the constraints of electromagnetic and thermal compatibility. They most often have an arrangement such that the connectors are subject to electromagnetic interference. The evacuation of heat is also problematic due to the non-optimal arrangement of the elements between them, which limits the compactness of these polyphase electric machines. Such a compact arrangement would however be advantageous notably to limit the costs and to allow use in vehicles, for example electric vehicles. There are further requirements for the polyphase electric machine to be able to continue to operate despite a partial failure of these components.

### BRIEF SUMMARY

The aim of the present disclosure is to propose a solution which responds to all or part of the aforementioned problems and notably:
to propose a solution allowing the production of a compact polyphase electric machine and allowing a satisfactory evacuation of the heat:
to propose a solution allowing the obtaining of a polyphase electric machine limiting the electromagnetic disturbances:
to propose a solution making it possible to obtain a polyphase electric machine having satisfactory resilience to partial failures of these components.

This can be achieved by means of a polyphase electric machine comprising a first moving assembly and a second moving assembly movable in rotation relative to each other along an axis of rotation of the polyphase electric machine, polyphase electric machine in which:
the first moving assembly comprises:
   a ferromagnetic material support structure formed of a peripheral portion delimiting a central housing and from which extend a plurality of coil support projections oriented transversely to said axis of rotation in the direction of the central housing:
   a plurality of coils, each coil being capable of generating a respective coil magnetic field when a respective input electrical potential supplies a first terminal of said coil and when a respective output electrical potential, different from the of respective input electrical potential, supplies a second terminal of said coil;
      each coil covering all or part of at least one of said coil support projections:
the second moving assembly is arranged at least partly in said central housing and is free relative to the first moving assembly, the second moving assembly comprising:
   a plurality of magnetic elements, each magnetic element being configured to deliver a magnetic field of respective second moving assembly, able to interact with the coil magnetic field generated by one of the coils of the first moving assembly, in a manner imposing a relative rotational movement between the first moving assembly and the second moving assembly about said axis of rotation when the respective input electrical potential and the respective output electrical potential are applied to the coils of the first moving element;
      the first and second moving assemblies together defining first and second opposite lateral faces of the polyphase electric machine, offset relative to each other along the axis of rotation of the polyphase electric machine:
      the polyphase electric machine further comprising:
at least one phase generator comprising a plurality of control assemblies, each control assembly containing an input module supplying the first terminal of at least one of the coils of the plurality of coils and an output module supplying the second terminal of said at least one coil of the plurality of coils:
   the input module being capable of generating the respective input electrical potential applied to said at least one coil of the plurality of coils from at least one current and/or voltage source selected among a first DC current and/or voltage source and a second DC current and/or voltage source to which the polyphase electric machine is connected:
   the output module being capable of generating the respective electrical output potential applied to said at least one coil of the plurality of coils from the first current and/or voltage source and/or from the second DC current and/or voltage source to which the polyphase electric machine is connected:
   the respective input electrical potential and the respective output electrical potential being configured to generate a respective phase in said at least one coil of the plurality of coils:
   the respective phases being different from each other;
   the input and output modules being arranged at the level of the first lateral face and at the level of the second lateral face of the polyphase electric machine.

In one implementation of the polyphase electric machine, the first moving element comprises a plurality of primary cooling elements, each primary cooling element comprising a first portion as well as a second portion and allowing a transfer of a heat flow from the first portion of the primary cooling element to the second portion of the primary cooling element: the first portion of the primary cooling elements being arranged through or between the coil support projections so as to be surrounded at least in part by the ferromagnetic material of the support structure:

the second portion of the primary cooling elements being arranged outside the support structure.

In one implementation of the polyphase electric machine, the support structure delimits a plurality of cooling projections, formed from the same ferromagnetic material as the rest of the support structure, extending transversely from the peripheral portion of the support structure:

at least one of the cooling projections being arranged between two adjacent coil support projections so that said cooling projection is crossed by the first portion of at least one of the primary cooling elements.

In one implementation of the polyphase electric machine, the second moving element comprises a plurality of secondary cooling elements, each secondary cooling element comprising a first portion as well as a second portion and allowing a transfer of a heat flow from the first portion of the secondary cooling element to the second portion of the secondary cooling element;

the first portion of the secondary cooling elements being arranged between adjacent magnetic elements of the plurality of magnetic elements;
the second portion of the secondary cooling elements being arranged outside the second moving assembly.

In one implementation of the polyphase electric machine, at least one of the primary cooling elements or at least one of the secondary cooling elements is galvanically insulated from the ferromagnetic material.

In one implementation of the polyphase electric machine, the primary cooling elements or the secondary cooling elements are heat pipes.

In one implementation of the polyphase electric machine, the primary cooling elements or the secondary cooling elements are formed at least in part from a material selected among copper, aluminum, aluminum alloy or aluminum oxide.

In one implementation of the polyphase electric machine, the second portion of the primary cooling elements or the second portion of the secondary cooling elements extends along a longitudinal axis and comprises a heat sink formed of one or more structures extending radially about this longitudinal axis.

In one implementation of the polyphase electric machine, a holding mechanism interconnects the second portions of at least two of the primary cooling elements or the second portions of at least two of the secondary cooling elements.

In one implementation of the polyphase electric machine, the coils are galvanically insulated from the coil support projections.

In one implementation of the polyphase electric machine, the sum of the number of input modules and the number of output modules is greater than or equal to 20.

In one implementation of the polyphase electric machine, the sum of the number of input modules and the number of output modules is an even multiple of one of the prime numbers 3, 5 or 7.

In one implementation of the polyphase electric machine, the input modules are arranged at the level of the first lateral face and the output modules are arranged at the level of the second lateral face.

In one implementation of the polyphase electric machine, the input module and the output module of a same control assembly are arranged at the level of a same lateral face selected from the first lateral face and the second lateral face.

In one implementation of the polyphase electric machine, the coils are connected to a connection device disposed at the level of at least one of the first lateral face and the second lateral face, the connection device being configured to electrically connecting one or more coils of the plurality of coils together.

In one implementation of the polyphase electric machine, the coil support projections have one end facing the central housing which is divided into a first secondary projection and a second secondary projection;

at least one of the plurality of coils partially covering the first secondary projection of one of the coil support projections and the second secondary projection of one of the coil support projections adjacent to said coil support projection.

In one implementation of the polyphase electric machine, the polyphase electric machine comprises a control device configured to control the input modules and the output modules so that each of the phases can be varied.

In one implementation of the polyphase electric machine, the first and second moving assemblies have a generally cylindrical shape with an axis coinciding with the axis of rotation of the polyphase electric machine.

In one implementation of the polyphase electric machine, the support structure is formed by a pile of secondary structures along the axis of rotation of the polyphase electric machine, each secondary structure having a thickness less than a total thickness of the first moving assembly counted in the direction of the axis of rotation of the polyphase electric machine.

In one implementation of the polyphase electric machine, the magnetic elements are permanent magnets.

In one implementation of the polyphase electric machine, the first moving assembly forms a stator and the second moving assembly forms a rotor secured to a shaft to be driven.

In one implementation of the polyphase electric machine, the magnetic elements extend radially from the shaft to be driven.

In one implementation of the polyphase electric machine, the magnetic elements comprise a first material having first magnetic properties and oriented towards the shaft to be driven and a second material having second magnetic properties and oriented towards the stator, the second magnetic properties being less degraded by an increase in temperature than the first magnetic properties.

In one implementation of the polyphase electric machine, the first material is NdFeB and the second material is SmCo.

In one implementation of the polyphase electric machine, a stirring device, secured to the second moving element, is configured to move a fluid surrounding the shaft to be driven when the second moving assembly is rotated.

The disclosure also relates to a vehicle including such a polyphase electric machine.

### BRIEF DESCRIPTION OF THE DRAWINGS

Other aspects, advantages and characteristics of the disclosure will appear better on reading the following detailed description of preferred embodiments thereof, given by way of non-limiting example, and made with reference to the appended drawings on which:

FIG. 1 represents a side view of an example of a polyphase machine according to the disclosure, the input and output modules being arranged in a total number equal at the level of the first lateral face and at the level of the second lateral face.

FIG. 2 represents a diagrammatic exploded perspective view of an example on the one hand of a first moving assembly according to the disclosure, having cooling projections forming a stator, and comprising primary cooling elements with sinks and on the other hand a second moving assembly forming a rotor intended to be arranged in the central housing and comprising secondary cooling elements.

FIG. 3 represents a front view of an example of control assemblies before their installation on the lateral faces of the polyphase machine.

FIG. 4 represents a schematic perspective view of a connection disc connected to different coils of a first moving assembly.

FIG. 5 represents a partial perspective view of a pile of secondary structures of the ferromagnetic lamination type forming the support structure according to the disclosure.

FIG. 6 represents a schematic perspective view of an example on the one hand of a first moving assembly according to the disclosure, forming a stator, and comprising primary cooling elements with sinks and on the other hand a second moving assembly forming a rotor arranged in the central housing and comprising secondary cooling elements whose second portions are connected by a holding mechanism.

FIG. 7 represents a schematic partial front view of an example of the support structure according to the disclosure in which the coil support projections have one end facing the central housing which is divided into a first secondary projection and a second secondary projection.

FIG. 8 represents a schematic perspective view of an example of a second moving assembly according to the disclosure, to which a stirring device is secured, forming a rotor and being arranged in the central housing of a first moving assembly forming a stator comprising primary cooling elements.

FIG. 9 represents a partial perspective front view of an example of a second moving assembly according to the disclosure in which the magnetic elements comprise a first material and a second material.

FIG. 10 represents an electrical diagram of an example of a phase generator according to the disclosure, comprising a first current and/or voltage source, and in which the input and output modules supplying a first terminal and respectively a second terminal of a same coil are arranged at the level of a same lateral face.

FIG. 11 represents an electrical diagram of an example of a phase generator according to the disclosure, comprising a first current and/or voltage source, and in which the input and output modules supplying a first terminal and respectively a second terminal of a same coil are arranged at the level of a first lateral face and respectively at the level a second lateral face, the number of input modules being ten in number, the number of output modules also being ten in number.

FIG. 12 represents an electrical diagram of an example of a phase generator according to the disclosure, comprising a first and a second current and/or voltage source, and in which the input and output modules supplying a first terminal and respectively a second terminal of a same coil are arranged at the level of a same lateral face.

FIG. 13 represents an electrical diagram of an example of a phase generator according to the disclosure, comprising a first and a second current and/or voltage source, and in which the input and output modules supplying a first terminal and respectively a second terminal of a same coil are arranged at the level of a first lateral face and respectively at the level of a second lateral face.

FIG. 14 represents an electrical diagram of an example of a phase generator according to the disclosure, comprising a first current and/or voltage source, and in which the input and output modules supplying a first terminal and respectively a second terminal of a same coil are arranged at the level of a first lateral face and respectively at the level of a second lateral face, the number of input modules being five in number, the number of output modules also being five in number.

### DETAILED DESCRIPTION

In the figures and in the remainder of the description, the same references represent identical or similar elements. In addition, the various elements are not represented to scale so as to favor the clarity of the figures. Furthermore, the different embodiments and variants are not mutually exclusive and can be combined with one another.

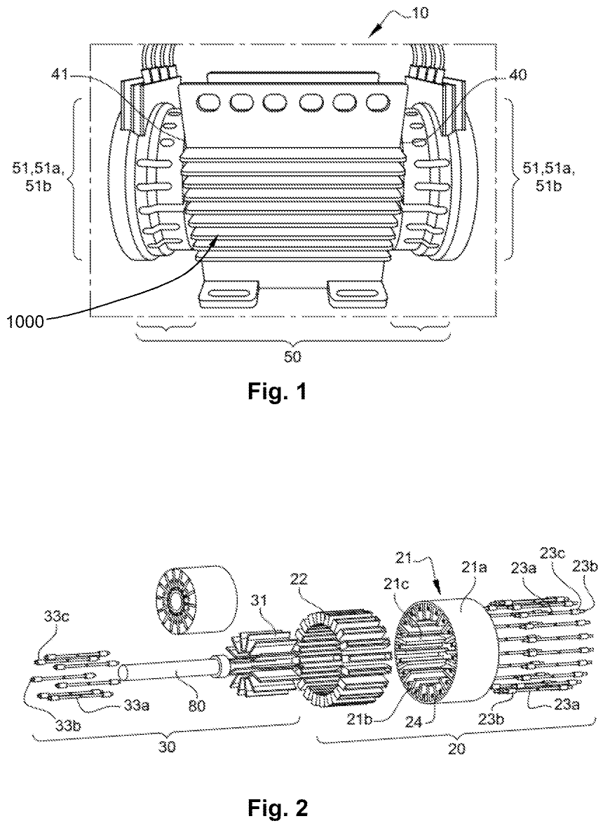

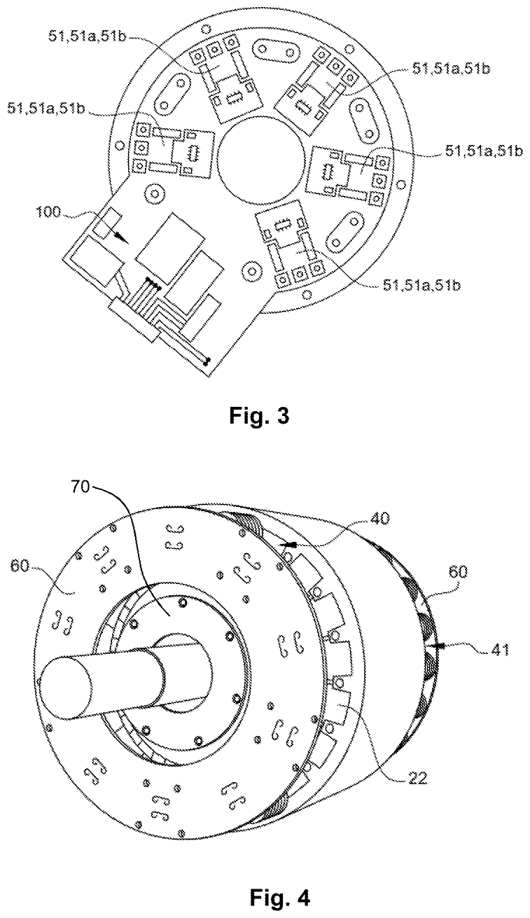

As illustrated in FIG. 1, the disclosure firstly concerns a polyphase electric machine 10. The polyphase electric machine 10 comprises first of all a first moving assembly 20 and a second moving assembly 30 rotatably movable relative to each other along an axis of rotation of the polyphase electric machine 10.

In one implementation example illustrated in FIGS. 2, 4, 6 and 8, the first and second moving assemblies 20, 30 are cylindrical. The axis of rotation of the polyphase electric machine 10 is then merged with the axis of revolution of the cylinders.

In one implementation example, the first moving assembly 20 is a stator. The stator can be fixed to the body of an electric car, for example. The second moving assembly 30 then forms a rotor. The rotor can for example, as illustrated in FIGS. 2, 4, 6 and 8, be secured to a shaft to be driven 80. This shaft to be driven can notably be used to move an electric vehicle. Conversely, if the shaft to be driven 80 is rotated by an element external to the machine, then an electric current could be generated in the stator.

In one example, not illustrated and different from the previous implementation, the first moving assembly 20 forms a rotor and the second moving assembly 30 then forms a stator. The shaft to be driven 80 would then be arranged at the level of an external area of the rotor and would therefore be hollow. Such an arrangement can be used in wind turbines for example.

In all implementations of the disclosure, the first moving assembly 20 comprises a support structure 21 formed of a peripheral portion 21a delimiting a central housing 21c. The support structure 21 is made of ferromagnetic material because this makes it possible to increase and concentrate the magnetic fields. A ferromagnetic material can be made with a metal containing iron or cobalt or nickel or a mixture thereof.

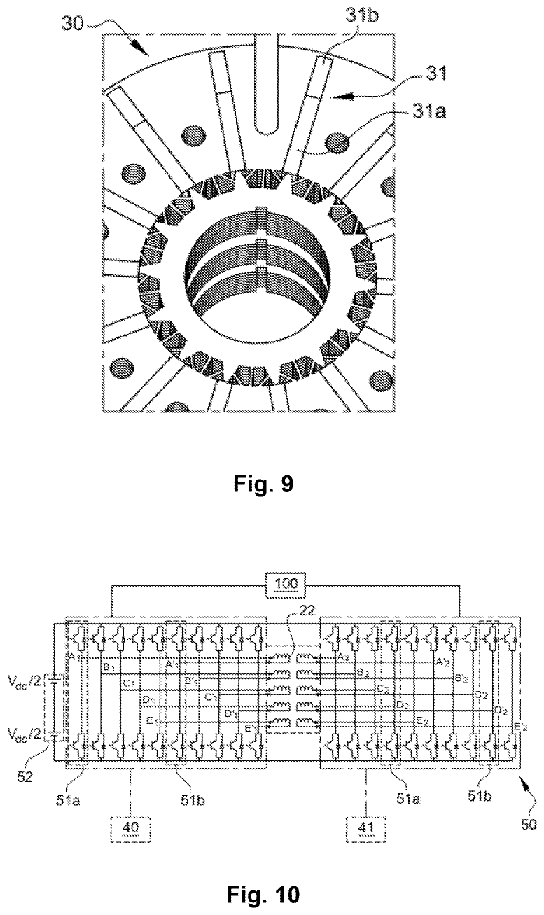

In one implementation example illustrated in FIG. 9, the support structure 21 is formed by a pile of secondary structures 21d along the axis of rotation of the polyphase electric machine 10. In this example, each secondary structure 21d has a thickness less than a total thickness of the first moving assembly 20 counted in the direction of the axis of rotation of the polyphase electric machine. This makes it possible to limit production costs.

In the technical field of the present disclosure, the secondary structures 21d can also be called laminations, notably ferromagnetic, the pile of which makes it possible to form the support structure 21. According to a particular formulation of the technical field of the disclosure, a lamination stack can form the pile of secondary structures 21d and therefore the support structure 21. Each lamination can then have a particular cutout suitable for the formation of the support structure 21 by lamination pile; these piled laminations being ultimately fixed together.

In the technical field of the present disclosure, the support structure 21 can also be called yoke. The yoke is conventionally intended to be housed in a casing also called frame 1000 (FIG. 1). The frame 1000 can be made of a solid material such as cast iron, aluminum, cast aluminum or steel, these materials being good thermal conductors. The frame 1000 can have mechanical and thermal functions since it provides the interfacing of the yoke with the exterior. The frame 1000 can include fins or ribs which increase the external heat exchange surface of the polyphase electric machine 10.

In the disclosure, a plurality of coil support projections 21b extend from the support structure 21 and are oriented transversely to said axis of rotation in the direction of the central housing 21c. By transversely it should be understood, in a similar way, that the coil support projections 21b radially extend towards the central housing 21c, which is the case for example when the general shape of the first and second moving elements 20, 30 is cylindrical.

In an implementation example illustrated in FIGS. 2, 4, 6-8, the first moving assembly 20 further comprises a plurality of coils 22. Each coil 22 generates a respective coil magnetic field when a respective input electrical potential supplies a first terminal of said coil 22 and when a respective output electrical potential, different from the respective input electrical potential, supplies a second terminal of said coil 22. In other words, each coil 22 of the plurality generates a magnetic field when a voltage is applied across it. The coils 22 can be single or double layers, that is to say two parts of two adjacent coils 22 are arranged, while being separated, in a same cavity of the support structure 21. This configuration example is advantageous in that the coils 22 are independent and without contact at the level of the coil heads. This guarantees a certain thermal insulation between them in the event of a fault, such as when a current is too high in a coil 22.

In particular, the or each coil 22 can be supplied with alternating current which results in that the direction of circulation of the current in said coil 22 changes (the current is reversed in an alternating manner) over time: in other words, the magnetic field generated by said coil 22 is dependent on a potential difference imposed on said coil 22. Thus, the or each coil 22 can be supplied in such a way that alternately:
its first terminal is supplied by the input potential and its second terminal is supplied by the output potential;
its first terminal is supplied by the output potential and its second terminal is supplied by the input potential.

The terminals of several coils 22 can be connected together for example via a connection device 60) as illustrated in FIG. 4. This connection device can contain conductive tracks which specifically connect certain coils 22 together. Thus, the coils 22 can be independent of each other then, depending on the application in which the polyphase electric machine is used, a different connection device 60 can be envisaged with a different internal connection circuit. This principle makes it possible both to limit the length of the connectors but also to obtain versatility of the configurations without having to change the general design of the polyphase electric machine depending on the applications. The connection of several coils together also makes it possible to obtain coils emitting a magnetic field over a larger surface or an increased magnetic field depending on the characteristic of the connection. This also makes it possible to modify the supply voltages of the coils according to the used current and/or voltage source. The coils 22 are for example made of copper but can be galvanically insulated from the rest of the components of the first or second moving element 20, 30 and notably from the ferromagnetic material. They can be made in advance, before introduction around the support projections 21b as can be seen in FIG. 2, which reduces the production cost.

For example, the coils 22 can each be made of an electrically (galvanically) insulated copper wire, which can provide a first electrical protection.

In particular, the coils 22 can be galvanically insulated relative to the coil support projections 21b; this insulation can be achieved by notch-bottom insulators which can then provide a second electrical protection capable of overcoming a failure of the first electrical protection mentioned above, the notches each being delimited between two adjacent coil support projections 21b. By notch-bottom insulator is meant an insulator on the surface of a corresponding notch which makes it possible to provide electrical insulation between the support structure 21 and the coils 22, for example, where appropriate, in addition to the first electrical protection provided on the coils 22, for example around the copper wires of these coils 22. In particular, when the lamination stack forms the first moving assembly 20, this lamination stack can also be electrically connected to earth.

Preferably, the polyphase electric machine 10 comprises a coil system, or more simply called coil, of the dental concentric type: this coil system comprises the coils 22 arranged so that they do not touch each other and so that they are each wound in whole or in part around a corresponding support projection 21b also called a <<tooth>>, the winding of a corresponding coil which can be closed again above the corresponding tooth: of course, as mentioned previously, each coil 22 is galvanically insulated from the support projection 21b that it surrounds. An advantage of the coil system as described is that by avoiding contact between the coils 22, this makes it possible to produce fault-tolerant polyphase electric machines: if there is a thermal type problem on a coil 22, heat propagation is less easy than if the coils are touching. In addition, another advantage of the coil system as described is that by avoiding contact of the coils 22 with each other, this makes it possible to avoid a short-circuit if a surface insulator of the coils 22 were to melt relative to a solution where the coils 22 would be in contact.

Each coil 22 covers all or part of at least one of said coil support projections 21b. Thus, in an implementation example, the coils 22 form turns, in other words pseudo-loops, and the empty central space of the turns of a coil 22 is inserted around a coil support projection 21b. This is visible for example in FIG. 2 or 4. The coil support projections 21b thus form air gaps for the coils 22.

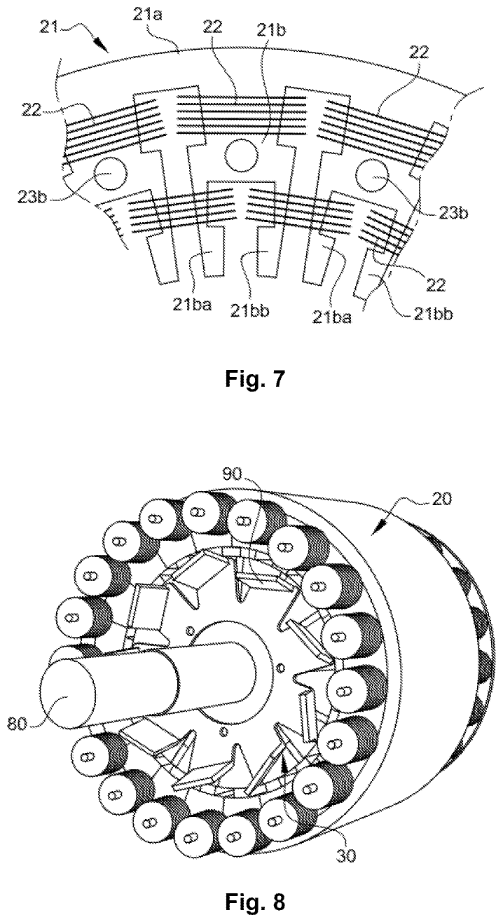

In an implementation example illustrated in FIG. 7, the coil support projections 21b have one end facing the central housing 21c which is divided into a first secondary projection 21ba and a second secondary projection 21bb. The first and second secondary projections 21ba, 21bb thus form protuberances, separated from each other, at the end of the coil support projections 21b. The first and second secondary projections 21ba, 21bb are also formed in a ferromagnetic material, preferably the same as that of the support structure 21. In this example, at least one of the coils 22 of the plurality of coils partly covers the first secondary projection 21ba of one of the coil support projections 21b and the second secondary projection 21bb of one of the coil support projections 21b adjacent to said coil support projection 21b. The coils 22 are then formed by winding in situ. Such an example makes it possible to increase the intensity of the magnetic fields coming from the coils 22 as well as their density and the overall compactness. This implementation example is also compatible with the example where the support structure 21 is formed by a pile of secondary structures 21d.

The second moving assembly 30 is arranged at least partly in said central housing 21c and is free relative to the first moving assembly 20. The term <<free>> means <<mechanically free>> but does not exclude interactions due to magnetic fields.

In an implementation example, the second moving assembly 30 is formed by a pile of secondary structures along the axis of rotation of the polyphase electric machine 10. Each secondary structure then has a thickness less than a total thickness of the second moving assembly 30 counted in the direction of the axis of rotation of the polyphase electric machine. This reduces the manufacturing cost. A ferromagnetic material is preferably used to manufacture the secondary structures of the second moving assembly. This makes it possible to guide and densify the magnetic fields coming from the magnetic elements 31.

The secondary structures of the second moving assembly 30 can also be called laminations, notably ferromagnetic, and can each have a particular cut-out adapted to the formation of the second moving assembly 30 by lamination pile; these piled laminations being ultimately fixed together.

As illustrated in FIGS. 2, 6, 9, the second moving assembly 30 comprises a plurality of magnetic elements 31. Each magnetic element 31 is configured to deliver a magnetic field of the respective second moving assembly. This magnetic field is formed to successively interact with the coil magnetic field generated by one of the coils 22 of the first moving assembly 20. By successively interacting with each of the coil magnetic fields, generated when the respective input electrical potential and the respective output electrical potential are applied to the coils 22, this induces a relative rotational movement between the first moving assembly 20 and the second moving assembly 30 about said axis of rotation.

In one implementation example illustrated in FIGS. 2, 6 and 9, the magnetic elements 31 extend radially from the shaft to be driven 80. In one example, the magnetic elements 31, arranged along two different but adjacent radii, are arranged so that their north poles face each other. This allows the magnetic field generated by two adjacent magnetic elements 31 to be pushed back to the maximum by the coil magnetic field relative to each of the coils 22, when the latter pass at the level of the magnetic elements 31 in question. The interaction between the different magnetic fields thus produces an optimized force for moving the rotor relative to the stator.

In a complementary implementation example illustrated in FIG. 9, the magnetic elements 31 are permanent magnets. The magnetic elements 31 can comprise a first material 3la having first magnetic properties and oriented towards the shaft to be driven 80 and a second material 31b having second magnetic properties and oriented towards the stator. The second magnetic properties must be such that they are less degraded by an increase in temperature than the first magnetic properties. In other words, the magnetic elements 31 which are located towards the stator are more likely to undergo eddy currents due to the presence of the coils 22 nearby. This results in a heating of the magnetic elements 31 arranged as close as possible to the coils 22. It is therefore appropriate that their magnetic properties are only slightly degraded by the rise in temperature. Nevertheless, this type of magnetic element is relatively expensive and this is why, in one example, a first material 31a is used on the parts of the magnetic elements 31 furthest from the coils 22. This first material 31a retains less its magnetic characteristics with a high temperature compared to the second material 31b. The magnetic properties are for example linked to the Curie temperature which varies for each type of material. In an implementation example, the first material 31a is NdFeB and the second material 31b is SmCo.

Alternatively, the magnetic elements 31 can be coils which are electrically supplied with current to each generate a magnetic field which behaves similarly to the magnetic field of a permanent magnet.

As illustrated in FIG. 1, the first and second moving assemblies 20, 30 together define first and second opposite lateral faces 40, 41 of the polyphase electric machine. These first and second faces are offset relative to each other along the axis of rotation of the polyphase electric machine.

As illustrated in 3, 10-14, the polyphase electric machine further comprises at least one phase generator 50. The phase generator 50 comprises a plurality of control assemblies 51. Each control assembly 51 contains an input module 51a supplying the first terminal of at least one of the coils of the plurality of coils 22 and an output module 51b supplying the second terminal of said at least one coil 22 of the plurality of coils 22. The input and outputs 5la, 51b modules comprise notably an assembly of transistors, able to be controlled and combined with diodes. The input module 51a generates the respective input electrical potential, which varies over time depending on the command received by the transistors. The respective input electrical potential is applied to said at least one coil of the plurality of coils 22 from a first and/or a second DC current and/or voltage source 52,53 at which the polyphase electric machine is connected. The output module 51b generates the respective output electrical potential, which varies over time depending on the command received by the corresponding transistors of the output module. The respective output electrical potential is applied to said at least one coil 22 of the plurality of coils 22 from the first current and/or voltage source 52 and/or from the second DC current and/or voltage source 53 to which the polyphase electric machine is connected. The first current and/or voltage source 52 and the second current and/or voltage source 53 can be electric vehicle batteries.

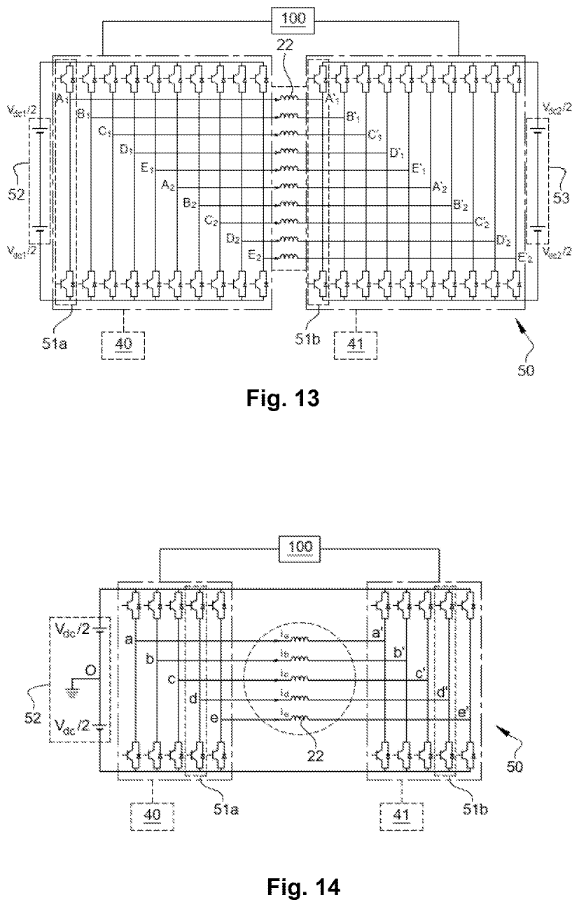

In an implementation example illustrated in FIGS. 12 and 13, the respective output electrical potential is applied to said at least one coil 22 of the plurality of coils 22 from the second current and/or voltage source 53.

In all the implementation example, the respective input electrical potential and the respective output electrical potential are configured to generate a respective phase in said at least one coil 22 of the plurality of coils 22. This is for example possible by controlling the transistors of the input module 51a and of the output module 51b, respectively connecting the first and the second terminal of a same coil 22, so that the respective electric input potential and the electric output potential define a phase. The respective phases at the level of a coil 22, or multiple coils 22 when connected together, are different from each other. This makes it possible to create a series of magnetic fields out of phase with each other which will come to interact with the magnetic fields of the magnetic elements of the rotor to move the rotor relative to the stator.

In an implementation example, the polyphase electric machine 10 comprises a control device 100 configured to control the input modules 51a and the output modules 51b so as to be able to vary each of the phases. The control device 100 thus synchronizes the input and output modules 51a, 51b with each other to form each phase. The control device 100 also organizes the phase difference between each phase generated by each control assembly according to the torque or speed requirements.

More particularly, the control device 100 can be configured to control the input modules 51a and the output modules 51b so as to be able to vary the current in each of the phases.

In all implementations of the disclosure, the input and output modules 51a, 51b should be arranged at the level of the first lateral face 40 and/or at the level of the second lateral face 41 of the polyphase electric machine 10 as illustrated in FIGS. 1 and 10-14. The term <<at the level>> means equivalently <<in direct or indirect contact through a connecting space or device>>. The phase generator 50 thus behaves like two inverters, each arranged on a different one of the first or second lateral faces 40, 41. Each inverter then having one arm per input or output 51a, 51b module.

More particularly, each inverter can comprise one or more input modules 51a and/or one or more output modules 51b and one inverter arm per input or output module that said inverter comprises, each arm connecting the input or output module corresponding to the associated current and/or voltage source to which said inverter is connected. The inverters are therefore part of the polyphase electric machine 10.

Preferably, the inverters are placed inside the frame 1000. This allows the following advantages:
there is no longer any need to use power cables through which alternating current passes and which run in the external environment of the first and second moving assemblies 20, 30, for example between the inverters and the first and second moving assemblies 20, 30, everything can be integrated for example by using suitable electrically conductive tracks, this making it possible to limit the disturbance of the electromagnetic environment external to the polyphase electric machine 10:
this can limit or eliminate the problems of electromagnetic compatibility with the environment outside the polyphase electric machine 10 in the case where the frame 1000 has an electromagnetic shielding function:
this allows a reduction and control of the lengths of electrical connections within the polyphase electric machine 10 and therefore to limit overvoltage phenomena (due to wave reflection) when the coils 22 are supplied by high frequency inverter(s), for example of the SiC or GaN type.

For example, the inverters are arranged orthogonally relative to the axis of rotation of the polyphase electric machine 10. This allows <<axial>> positioning of the inverters, for example on either side of the support structure 21 along the axis of rotation of the polyphase electric machine 10: this axial positioning being more favorable for connecting the coils 22 to the inverters with control over the lengths of electrical conductors for these connections. In the case where the first moving assembly 20 is movable in rotation along the axis of rotation then the inverters are in the form of a ring.

In an implementation example not illustrated, the number resulting from the addition of the number of input and output modules 51a, 51b is different at the level of the first face 40 compared to that of the second lateral face 41. This arrangement makes it possible to increase the distribution of the heat dissipation.

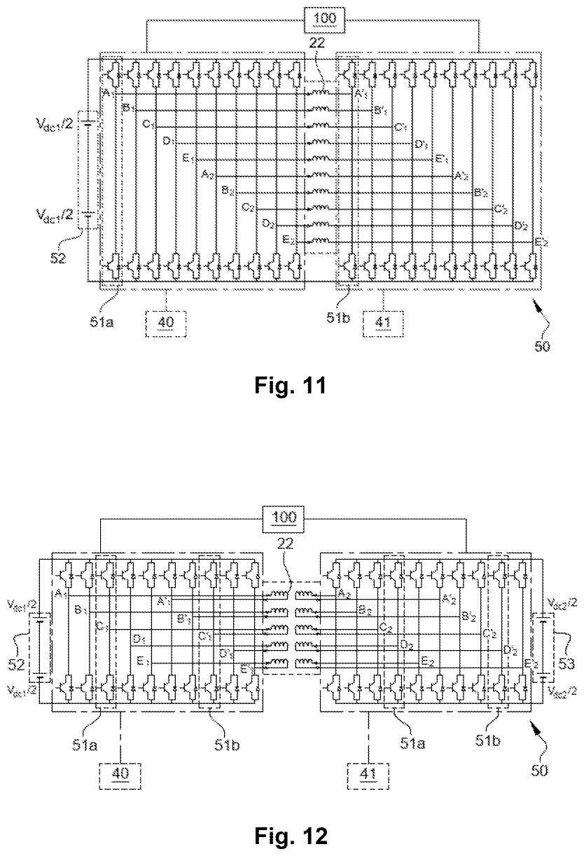

In an implementation example, illustrated in FIGS. 11, 13 and 14, the input modules 51a are arranged at the level of the first lateral face 40 and the output modules 51b are arranged at the level of the second lateral face 41. In this example, the first input modules 51a are therefore arranged symmetrically relative to the second output modules 51b on either side of the polyphase electric machine. This makes it possible to limit the extent of the connectors, which limits the generation of electromagnetic disturbances, notably outside the polyphase electric machine 10. In addition, the symmetrical distribution in a balanced manner between each lateral face 40, 41 makes it possible to distribute homogeneous heating due to the operation of the transistors of the input and output modules 51a, 51b. The cooling is thus more efficient and better controlled. Furthermore, more generally, this makes it possible to distribute the heating within the polyphase electric machine 10.

In an implementation example illustrated in FIG. 10, the input module 51a and the output module 51b of a same control assembly 51 are arranged at the level of a same lateral face selected among the first lateral face 40 and the second lateral face 41. The input and output modules 51a, 51b are supplied by a single first current and/or voltage source 52. In this example, the total number of input and output modules 51a, 51b arranged on the first lateral face 40 is equal to the total number of input and output modules 51a, 51b arranged on the second lateral face 40. This makes it possible to evenly distribute the heating due to the operation of the transistors of the input and output 51a, 51b modules. The cooling is thus more efficient.

In an implementation example illustrated in FIG. 12, the input module 51a and the output module 51b of a same control unit 51 are arranged at the level of a same lateral face selected among the first lateral face 40 and the second lateral face 41. The input and output modules 51a, 51b of a same lateral face 40, 41 are supplied by a same current and/or voltage source taken among the first current and/or voltage source 52 and/or the second current and/or voltage source 53.

In other words, in the example illustrated in FIG. 12, each coil 22 can be supplied by a single inverter and the polyphase electric machine 10 can comprise two inverters allowing the independent supply of two assemblies of coils 22, the coils of one of the coil assemblies being supplied by one of the inverters supplied by the first current and/or voltage source 52 on the side of the first lateral face 40, and the coils of the other of the coil assemblies being supplied by the other inverter supplied by the second current and/or voltage source 53 on the side of the second lateral face 41.

The example illustrated in FIG. 12 is particularly suitable for providing polyphase electric machine 10 with a tolerance allowing degraded operation in the event of failure of a power source selected from: the first current and/or voltage source 52, and the second current and/or voltage source 53.

The example illustrated in FIG. 13 also allows a tolerance authorizing degraded operation in the event of failure of a power source selected from: the first current and/or voltage source 52, and the second current and/or voltage source 53 but with a lower electrical impedance. Indeed, in the event of failure of one of the first and second current and/or voltage sources 52, 53, hereinafter referred to as the failed power source, the inverter attached to this failed power source behaves like a diode bridge (because there are diodes connected in parallel with transistors) and therefore currents can still flow even though there is no more voltage supplied by the failed power source.

In the previous implementation examples, it is advantageously possible for the input modules 5la and the output modules 51b to be powered both by the first current and/or voltage source 52 and the second current and/or voltage source 53. This arrangement allows that even if one of the two current and/or voltage sources is defective then the remaining current and/or voltage source can operate the polyphase electric machine 10 at least the time that a remedy be considered.

In the examples of FIGS. 10 to 13, the sum of the number of input modules 51a and the number of output modules 51b is equal to 20. This number can be higher to increase the number of phases or lower as shown in FIG. 14 if the first or second terminals of several coils 22 are connected together.

Generally in the disclosure, if the sum of the number of input modules 51a and output modules 51b is an even multiple of 3, of 5, of 7, or more generally of an even multiple of a prime number, then it is possible to supply the input modules 51a and the output modules 51b both by the first current and/or voltage source 52 and by the second current and/or voltage source 53. This arrangement allows that even if one of the two current and/or voltage sources is defective, then the remaining current and/or voltage source can operate the polyphase electric machine 10 at least for the time that a repair is envisaged.

The second current and/or voltage source 52 may be identical to the first current and/or voltage source 53.

In an implementation of the polyphase electric machine 10 illustrated in FIGS. 2, 6 and 8, the first moving element 20 comprises a plurality of primary cooling elements 23. This implementation and the following ones can be implemented independently of the characteristic which relates to the distribution along the first lateral face 40 and the second lateral face 41 of the input and output modules 51a, 51b. Each primary cooling element 23 includes a first portion 23a as well as a second portion 23b and allows a transfer of a heat flow from the first portion 23a of the primary cooling element 23 to the second portion 23b of the primary cooling element 23. The first portion 23a of the primary cooling elements 23 is arranged through or between the coil support projections 21b so as to be surrounded at least in part by the ferromagnetic material of the support structure 21. The term <<surrounded>> means <<surrounded directly or indirectly through a galvanic insulator>>. The second portion 23b of the primary cooling elements 23 is arranged outside the support structure 21. Thus, in one example, the primary cooling elements 23 are galvanically insulated relative to the ferromagnetic material of the support structure 21.

The primary cooling elements 23 can each extend partly into the yoke to promote the cooling of the coils 22.

In one example, the primary cooling elements 23 are heat pipes. This allows rapid and efficient evacuation of the heat from the inside of the first moving element 20 to the outside, in other words to the outside of the first moving element 20.

The heat pipes, or at least a part of them, as primary cooling elements 23, can also each have, depending on their design, a non-linear thermal resistance in the sense that said heat pipes can each participate, in function of the heat to be evacuated, either to heat transfer by thermal conduction or to heat transfer by evaporation which is more efficient than heat transfer by thermal conduction which results in that the thermal resistance of said heat pipe drops relative to the case where the heat transfer is done by thermal conduction.

In a complementary example, the primary cooling elements 23 are formed at least in part from a material selected among copper, aluminum, an aluminum alloy or an aluminum oxide. If aluminum is used, then a layer of aluminum oxide is likely to be formed naturally on the surface of the heat pipe, which will ensure natural galvanic insulation from the ferromagnetic material.

In an implementation example illustrated in FIGS. 2, 6 and 8, the second portion 23b of the primary cooling elements 23 extends along a longitudinal axis, for example parallel to the axis of rotation of the polyphase electric machine, and comprises a heat sink 23c formed of one or more structures extending radially about this longitudinal axis. The heat sink 23c can be composed of several discs which increases the heat dissipation. Other shapes can also be considered to maximize heat exchange.

In particular, the heat sink 23c of a corresponding primary cooling element 23 can be a heat pipe condenser when the primary cooling element 23 which comprises it is a heat pipe; the disks of this condenser then making it possible to increase the heat dissipation at the level of the condenser of said heat pipe.

In an example illustrated in FIG. 2, the second portion can be composed, if the heat pipe is through, by the two outer ends of the heat pipe or the outer end if only one end exists. The first portion can be formed by the joining of two portions of two heat pipes arranged in a reversed way. This allows an easier manufacturing.

In the implementation example, illustrated in FIG. 7, and where the coil support projections 21b have one end facing the central housing 21c which is divided into a first secondary projection 21ba and a second secondary projection 21bb, the first portion 23b of the primary cooling elements 23 is arranged in the coil support projections 21b. This arrangement improves compactness and heat dissipation.

In an implementation example illustrated in FIGS. 2 and 4, a plurality of cooling projections 24, formed from the same ferromagnetic material as the rest of the support structure 21, extending transversely from the peripheral portion 21a of the support structure 21. At least one of the cooling projections 24 is arranged between two adjacent coil support projections 21b so that said cooling projection 24 is crossed by the first portion 23a of at least one of the primary cooling elements 23. This arrangement makes it possible to effectively evacuate the heat coming from the coils 22. An advantage of this arrangement is that it makes it possible to integrate cooling into the support structure 21 without enlarging its section.

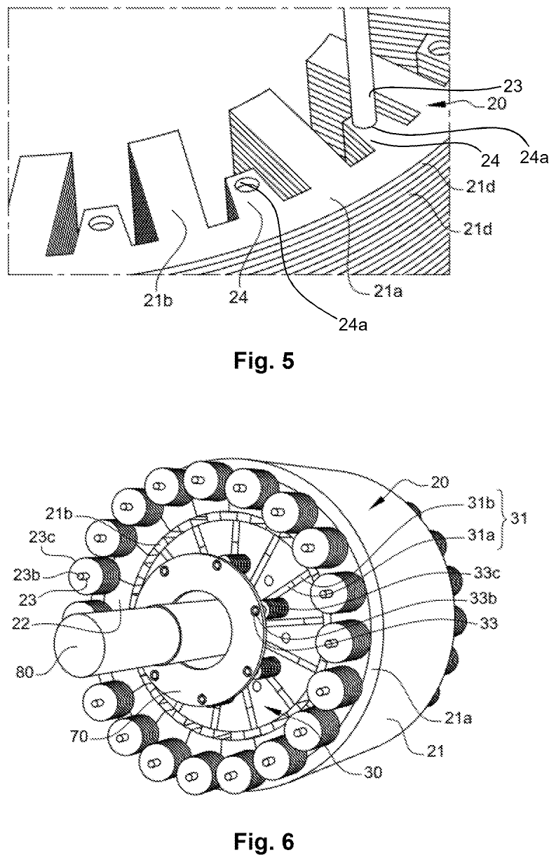

For example, the first moving assembly 20. and therefore notably the coil system mentioned above of this first moving assembly 20, can be such that the coil support projections 21b are arranged so as to delimit intermediate spaces (also called intermediate regions). each intermediate space being arranged between two coil support projections 21b. For example, the, or each, cooling projection 24 (also called a ferromagnetic projection) is arranged in one of the corresponding intermediate spaces and is pierced with a hole 24a (FIG. 5), notably circular, allowing it to house (for example by insertion) a portion of a corresponding heat pipe galvanically insulated from said cooling projection 24; the hole 24a extends for example along a longitudinal axis parallel to the axis of rotation of the polyphase electric machine 10. In FIG. 5, there is shown by way of illustration a primary cooling element 23 formed by a heat pipe inserted in a hole 24a corresponding to one of the cooling projections 24. In this paragraph. any mentioned heat pipe is one of the primary cooling elements 23. so what applies to heat pipes in this paragraph can apply more generally to the primary cooling elements 23. Notably, the heat pipes are electrically insulated from the cooling projections 24 to prevent the circulation of electric current between the heat pipes: if this were not the case, induced currents could circulate via the support structure 21 of a heat pipe to another heat pipe (as heat pipes are in areas where there are varying magnetic fields, there are induced voltages in these heat pipes: the electrical insulation makes it possible to obtain a high electrical impedance so that currents cannot be induced in the heat pipes), this could therefore induce additional electrical losses within the polyphase electric machine 10. The hole 24a of the or each, cooling projection 24 can make it possible to position the corresponding heat pipe in an appropriate manner in order to control the thermal resistance between the heat pipe passing through this hole 24a and the heat sources essentially formed by the coils 22. Furthermore, control of the geometry of the circular heat pipes for example for circular holes 24a can make it possible to ensure good thermal contact between the support structure 21 and each heat pipe despite the galvanic insulation present to avoid induced currents causing electrical losses within the polyphase electric machine 10 by electrical resistance in the support structure 21 and the heat pipes. Thus, it is here proposed to take advantage of intermediate spaces each able to receive a cooling projection 24, between two adjacent coils 22, in which a heat pipe is inserted/positioned. This makes it possible, with a view to limiting the production of heat, to place the, or each, heat pipe in a place where the magnetic field is weak because it is not in the path of the magnetic flux which essentially passes through the peripheral portion 21a and the coil support projections 21b. Indeed, the more the, or each, heat pipe (which can be made of an electrically conductive material such as copper or aluminum) is subjected to time-varying magnetic fields, the more the induced voltages which can be the source of induced currents will be significant: there is then a risk of producing heat. Furthermore, the presence of the heat pipes inserted in the cooling projections 24 dedicated to this makes it possible to easily insert the heat pipes (for example during assembly) or to be able to remove the heat pipes (for example for recycling, or for repair, of the polyphase electric machine 10). The insertion of a corresponding heat pipe in the corresponding hole 24a is advantageously done by avoiding damaging the electrical insulation between the heat pipe and the cooling projection 24. Of course, any heat pipe inserted into a corresponding hole 24a of the cooling projection 24 has a part outside this hole 24a, notably this part can comprise the heat sink 23c. Of course, when the support structure 21 is formed from a lamination stack, each lamination may comprise one or more holes to form, when the laminations of the lamination stack are suitably aligned, one or more holes 24a for the insertion of heat pipe(s) within the first moving assembly 20.

In an implementation of the disclosure illustrated in FIGS. 2 and 6, the second moving element 30 comprises a plurality of secondary cooling elements 33. Each secondary cooling element 33 includes a first portion 33a as well as a second portion 33b and it allows transfer of a heat flow from the first portion 33a of the secondary cooling element 33 to the second portion 33b of the secondary cooling element 33. The first portion 33a of the secondary cooling elements 33 is arranged between adjacent magnetic elements 31 of the plurality of magnetic elements 31. The second portion 33b of the secondary cooling elements 33 is also arranged outside the second moving assembly 30.

Thus, in one example, the secondary cooling elements 33 are galvanically insulated from the ferromagnetic material surrounding the magnetic elements 31.

In one example, the secondary cooling elements 33 are heat pipes. This allows rapid and efficient evacuation of the heat from the inside of the second moving element 30 to the outside.

The heat pipes or at least a part of them, as secondary cooling elements 33, can also each have, depending on their design, a nonlinear thermal resistance in the sense that said heat pipes can each participate, depending on the heat to be evacuated, either to a heat transfer by thermal conduction or to a heat transfer by evaporation which is more efficient than the heat transfer by thermal conduction which results in that the thermal resistance of said heat pipe drops relative to the case where the heat transfer is by thermal conduction.

In a complementary example, the secondary cooling elements 33 are formed at least in part from a material selected among copper, aluminum, an aluminum alloy or an aluminum oxide. If aluminum is used, then a layer of aluminum oxide is likely to be formed on the surface of the heat pipe, which will ensure natural galvanic insulation from the ferromagnetic material.

In an implementation example illustrated in FIGS. 2, 6 and 8, the second portion 33b of the secondary cooling elements 33 extends along a longitudinal axis, for example parallel to the axis of rotation of the polyphase electric machine, and comprises a heat sink 33c formed of one or more structures extending radially about this longitudinal axis. The heat sink 33c can be composed of several disks which increases the heat dissipation.

In particular, the heat sink 33c of a corresponding secondary cooling element 33 can be a corresponding heat pipe condenser when the secondary cooling element 33 which comprises it is a heat pipe: the disks of this condenser then making it possible to increase the heat dissipation at the level of the condenser of said heat pipe.

In an example illustrated in FIG. 2, the second portion can be composed, if the heat pipe is through, by the two outer ends of the heat pipe or the outer end if only one end exists. The first portion can be formed by the joining of two portions of two heat pipes arranged in a reversed way. This allows an easier manufacturing.

In an implementation example illustrated in FIGS. 4 and 6, a holding mechanism 70 interconnects the second portions 23b of at least two of the primary cooling elements 23 or the second portions 33b of at least two of the secondary cooling elements 33. The holding device 70 may for example be a drilled or tapped disc. Such an arrangement makes it possible to increase the mechanical strength of the assembly and limit vibrations. If the holding mechanism 70 is a thermal conductor then this may be advantageous to improve heat dissipation.

In an additional implementation example of the disclosure illustrated in FIG. 8, a stirring device 90, secured to the second moving element 30, makes it possible to move a fluid surrounding the shaft to be driven 80 when the second moving assembly 30 is rotated. The stirring device 90 can thus comprise fins which make it possible to deflect the fluid towards the coils 22 or the primary cooling elements 23. The fluid can be ambient air or else a liquid or a cloud of nonionic vapor. Such an arrangement allows effective cooling of the first and second moving elements 20, 30.

The disclosure also relates to a vehicle including such a polyphase electric machine. Such a vehicle has the advantage of being more compact and more resilient to failures.

In particular, the polyphase electric machine 10 as described can also be called an integrated polyphase electric machine in the sense that it comprises the phase generator 50, the first moving assembly 20 and the second moving assembly 30. Where appropriate, the integrated polyphase electric machine 10 can also comprise the control device 100.

1. A polyphase electric machine comprising a first moving assembly and a second moving assembly rotatably movable relative to each other along an axis of rotation of the polyphase electric machine, polyphase electric machine in which:
the first moving assembly comprises:
a support structure made of ferromagnetic material formed of a peripheral portion delimiting a central housing and from which extend a plurality of coil support projections oriented transversely to said axis of rotation towards the central housing;
a plurality of coils, each coil being capable of generating a respective coil magnetic field when a respective input electrical potential supplies a first terminal of said coil and when a respective output electrical potential, different from the respective input electrical potential, supplies a second terminal of said coil;
each coil covering all or part of at least one of said coil support projections;
the second moving assembly is arranged at least partly in said central housing and is free relative to the first moving assembly, the second moving assembly comprising:
a plurality of magnetic elements, each magnetic element being configured to deliver a magnetic field of respective second moving assembly, capable of interacting with the coil magnetic field generated by one of the coils of the first moving assembly, in a manner imposing a relative rotational movement between the first moving assembly and the second moving assembly about said axis of rotation when the respective input electrical potential and the respective output electrical potential are applied to the coils of the first moving element;
the first and second moving assemblies together defining first and second opposite lateral faces of the polyphase electric machine, offset relative to each other along the axis of rotation of the polyphase electric machine;
the polyphase electric machine further comprising:
at least one phase generator comprising a plurality of control assemblies, each control assembly containing an input module supplying the first terminal of at least one of the coils of the plurality of coils and an output module supplying the second terminal of said at least one coil of the plurality of coils;
the input module being capable of generating the respective input electrical potential applied to said at least one coil of the plurality of coils from at least one current and/or voltage source selected from a first DC current and/or voltage source and a second DC current and/or voltage source to which the polyphase electric machine is connected;
the output module being able to generate the respective output electrical potential applied to said at least one coil of the plurality of coils from the first current and/or voltage source and/or the second DC current and/or voltage source to which the polyphase electric machine is connected;
the respective input electrical potential and the respective output electrical potential being configured to generate a respective phase in said at least one coil of the plurality of coils;
the respective phases being different from each other;
the input and output modules (51a, 51b) being arranged at the level of the first lateral face and at the level of the second lateral face of the polyphase electric machine.

2. The polyphase electric machine according to claim 1, wherein the first moving element comprises a plurality of primary cooling elements, each primary cooling element including a first portion as well as a second portion and allowing a transfer of a heat flow from the first portion of the primary cooling element to the second portion of the primary cooling element;
the first portion of the primary cooling elements being arranged through or between the coil support projections so as to be surrounded at least in part by the ferromagnetic material of the support structure;
the second portion of the primary cooling elements being arranged outside the support structure.

3. The polyphase electric machine according to claim 2, wherein the support structure delimits a plurality of cooling projections, formed in the same ferromagnetic material as the rest of the support structure, extending transversely from the peripheral portion of the support structure;
at least one of the cooling projections being arranged between two adjacent coil support projections so that said cooling projection is crossed by the first portion of at least the one of the primary cooling elements.

4. The polyphase electric machine according to claim 1, wherein the second moving element comprises a plurality of secondary cooling elements, each secondary cooling element including a first portion as well as a second portion and allowing a transfer of a heat flow from the first portion of the secondary cooling element to the second portion of the secondary cooling element;
the first portion of the secondary cooling elements being arranged between adjacent magnetic elements of the plurality of magnetic elements;
the second portion of the secondary cooling elements being arranged outside the second moving assembly.

5. The polyphase electric machine according to claim 2, and according to claim 4, wherein at least one of the primary cooling elements or at least one of the secondary cooling elements is galvanically insulated from the ferromagnetic material.

6. The polyphase electric machine according to claim 2, and according to any of claim 4 or 5, wherein the primary cooling elements or the secondary cooling elements are heat pipes.

7. The polyphase electric machine according to claim 2, and according to any of claims 4 to 6, wherein the primary cooling elements or the secondary cooling elements are formed at least partly in a material selected from copper, aluminum, an aluminum alloy or an aluminum oxide.

8. The polyphase electric machine according to claim 2, and according to any of claims 4 to 7, wherein the second portion of the primary cooling elements or the second portion of the secondary cooling elements extends along a longitudinal axis and comprises a heat sink (23c, 33c) formed of one or more structures extending radially about this longitudinal axis.

9. The polyphase electric machine according to claim 2, and according to any of claims 4 to 8, wherein a holding mechanism interconnects the second portions of at least two of the primary cooling elements or the second portions of at least two of the secondary cooling elements).

10. The polyphase electric machine according to claim 1, wherein the coils are galvanically insulated relative to the coil support projections.

11. The polyphase electric machine according to claim 1, wherein the sum of the number of input modules and the number of output modules is greater than or equal to 20.

12. The polyphase electric machine according to claim 1, wherein the input modules are arranged at the level of the first lateral face and the output modules are arranged at the level of the second lateral face.

13. The polyphase electric machine according to claim 1, wherein the input module and the output module of a same control assembly are arranged at the level of a same lateral face selected from the first lateral face and the second lateral face.

14. The polyphase electric machine according to claim 1, wherein the coils are connected to a connection device arranged at the level of at least one of the first lateral face and the second lateral face, the connection device being configured to electrically connect one or more coils of the plurality of coils to each other.

15. The polyphase electric machine according to claim 1, wherein the coil support projections have an end directed towards the central housing which is divided into a first secondary projection and a second secondary projection;
at least one of the coils of the plurality of coils partially covering the first secondary projection of one of the coil support projections and the second secondary projection of one coil support projections adjacent to said coil support projection.

16. The polyphase electric machine according to claim 1, comprising a control device configured to control the input modules and the output modules so as to be able to vary each of the phases.

17. The polyphase electric machine according to claim 1, wherein the first and second moving assemblies have a generally cylindrical shape with an axis coinciding with the axis of rotation of the polyphase electric machine.

18. The polyphase electric machine according to claim 1, wherein the support structure is formed by a pile of secondary structures along the axis of rotation of the polyphase electric machine, each secondary structure having a thickness less than a total thickness of the first moving assembly counted in the direction of the axis of rotation of the polyphase electric machine.

19. The polyphase electric machine according to claim 1, wherein the magnetic elements are permanent magnets.

20. The polyphase electric machine according to claim 1, wherein the first moving assembly forms a stator and the second moving assembly forms a rotor secured to a shaft to be driven.

21. The polyphase electric machine according to claim 20, wherein the magnetic elements extend radially from the shaft to be driven.

22. The polyphase electric machine according to claim 21, wherein the magnetic elements comprise a first material having first magnetic properties and oriented towards the shaft to be driven and a second material having second magnetic properties and oriented towards the stator, the second magnetic properties being less degraded by an increase in temperature than the first magnetic properties.

23. The polyphase electric machine according to claim 22, wherein the first material is NdFeB and the second material is SmCo.

24. The polyphase electric machine according to any one of claim 20, wherein a stirring device, secured to the second moving element, is configured to move a fluid surrounding the shaft to be driven when the second moving assembly is rotated.

25. A vehicle including a polyphase electric machine according to claim 1.
